(19) United States
(12) Patent Application Publication
(10) Pub. No.: US 2006/0085233 A1
(43) Pub. Date: Apr. 20, 2006

(54) PEER-TO-PEER COMPLAINT SYSTEM AND METHOD

(75) Inventor: Dante Monteverde, Barrington Hills, IL (US)

Correspondence Address: SEYFARTH SHAW LLP, 55 E. MONROE STREET, SUITE 4200, CHICAGO, IL, 60603-5803, US

(73) Assignee: EMERGENCY 24, INC., Chicago, IL (US)

(21) Appl. No.: 10/711,992

(22) Filed: Oct. 18, 2004

(51) Int. Cl. G06F 9/44

(52) U.S. Cl. 705/7

(57) ABSTRACT

A method and system of managing and handling consumer complaints is provided. The method includes receiving a complaint from a consumer regarding a merchant, forwarding the complaint to the merchant for a merchant's response, displaying the complaint and the merchant's response, if one is received, for a plurality of users to opine as to the righteousness of the consumer and the merchant, receiving a plurality of users' opinions of righteousness, and displaying the users' opinions of righteousness as an averaged numerical representation.

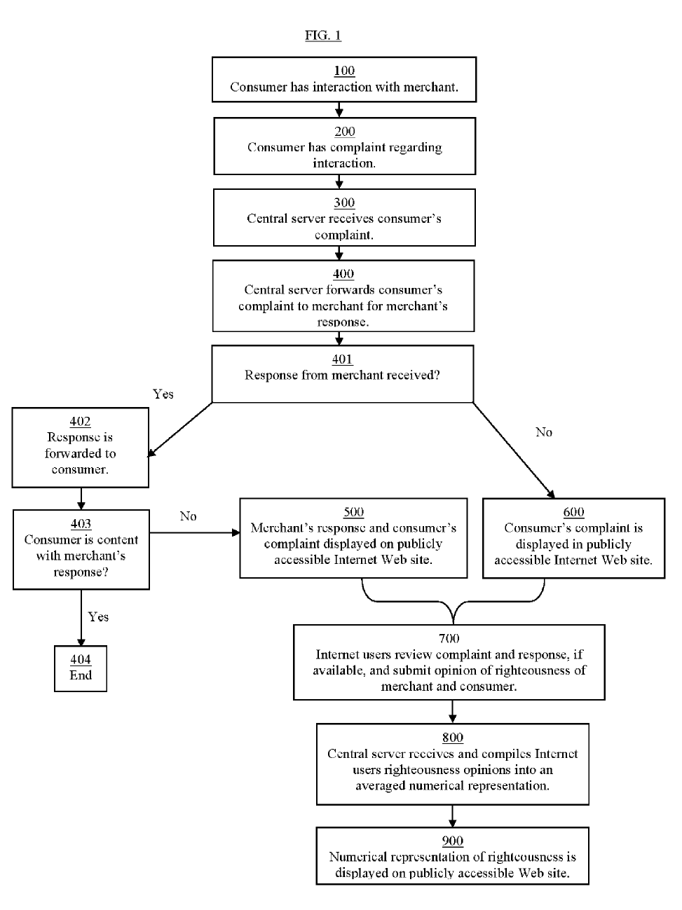

### BACKGROUND OF INVENTION

The present application relates generally to consumer complaints regarding transactions and interactions with merchants. More particularly, the present application relates to a system and method for handling and managing consumer complaints and provides an averaged numerical representation of other Internet users' analysis and opinions as to the righteousness of the consumer and the merchant.

When consumers have problems or complaints with their transactions with merchants, they typically resort to forwarding their complaint directly to the merchants. Generally, these complaints go unnoticed by other prospective consumers of the merchant, and the complaining consumer rarely sees any vindication or even an attempt to resolve the dispute from the merchant.

Many consumer complaint organizations have been established in order for consumers to submit formal complaints against a merchant. For example, the Better Business Bureau receives many consumer complaints, wherein prospective consumers can contact the Bureau to determine if a certain merchant has had complaints lodged against it. However, the Bureau does not provide a forum for the merchant or other consumers to comment on the complaint. Further, the Bureau is typically localized and only accepts complaints pertaining to a local merchant.

With the advent of the Internet and the proliferation of the global economy, better and more accurate methods of submitting and handling consumer complaints are required. Accordingly, there is needed a method and system wherein consumers who are unsatisfied with their interactions or transactions with a certain merchant can submit a complaint to an independent mediator, who then forwards the complaint to the merchant for response. Further, there is a need for publicly displaying both the complaint and the merchant's response for public scrutiny, wherein other consumers, either having good or bad experiences with the complained-of merchant or who believe or disbelieve the consumer's complaint or the merchant's response, can provide an opinion of righteousness and, wherein the mediator can then provide an averaged opinion of righteousness for prospective consumers to review.

### SUMMARY OF INVENTION

The present application discloses a method and system for managing consumer complaints. In an embodiment, a central server receives a complaint from a consumer regarding a merchant, forwards the complaint to the merchant for a merchant's response, displays the complaint and the merchant's response for user analysis of righteousness, receives at least one of the users' analyses of righteousness, and displays the users' analyses of righteousness as an averaged numerical representation. In another embodiment, verification of the opining users' respective identities is provided in order to ensure that the Internet user is not the merchant or the consumer, thus providing more accurate results of the averaged numerical representation.

### BRIEF DESCRIPTION OF DRAWINGS

For the purpose of facilitating an understanding of the subject matter sought to be protected, there is illustrated in the accompanying FIGURE an embodiment thereof, from an inspection of which, when considered in connection with the following description, the subject matter sought to be protected, its construction and operation, and many of its advantages, should be readily understood and appreciated.

The FIGURE is a flowchart depicting an embodiment of the present application.

### DETAILED DESCRIPTION

The present application discloses a method and system for handling and managing a consumer complaint regarding the consumer's interaction or transaction with a merchant. In an embodiment, the consumer is an Internet consumer and the merchant is an Internet merchant. Referring to the FIGURE, a consumer has an interaction or a transaction with a merchant 100. After the interaction or transaction, the consumer may have a complaint regarding the interaction or transaction 200. A mediator provides the consumer with a forum to register the complaint. In an embodiment, the mediator is a central computer server operably coupled to the Internet or a network. In an embodiment, the central server provides the consumer with an electronic complaint form and the consumer thus submits the complaint in an electronic format, which is received by the central server 300. The electronic complaint form may request information from the consumer such as, for example, the merchant's and consumer's name and identification information, the date of the interaction or transaction, the type of interaction or transaction, what portions of the interaction or transaction are complained of, the complaint, and any attempts by the consumer or the merchant to resolve the dispute. At the time of receiving the complaint, the central server may also automatically determine, verify and record the consumer's identification information, such as, for example, the Internet Protocol address of the computer used to send the complaint, the consumer's name, the consumer's geographic location, or other identifying information.

After the central server receives the complaint, the central server forwards the complaint, or a means to access the complaint, along with an electronic response form or a means to access such response form, to the merchant for the merchant's response 400, using a means for forwarding the complaint. In an embodiment, the means for forwarding the complaint forwards the complaint, or the means to access the complaint, along with an electronic response form or means to access such response form, electronically, such as, for example, electronic mail, in a well-known manner. It will be appreciated that many different methods and forms can be used to forward the complaint to the merchant.

After receiving and reviewing the complaint, the merchant has an opportunity to respond to the complaint, in the form of a response, or to disregard it. If the merchant decides to respond to the complaint, the merchant may log into the central server or it may respond to the electronically forwarded complaint and submit the response form in electronic form, which is provided by and subsequently received by the central server 401. The response form may request information such as, for example, the consumer's and merchant's name, the merchant's rendition of the facts contained in the complaint, and any actions taken by the merchant or consumer to resolve the complaint. Upon receiving the response, the central server may also determine and record the merchant's identification information, such as, for example, the Internet Protocol address of the computer used to send the response, the domain name of the merchant, the merchant's name, the merchant's geographic location or other identifying information.

If a response from the merchant is received by the central server, the central server will forward the response to the consumer for review 402. If the consumer is content with the response, the complaint is considered resolved and no more action is required 403, 404. If, however, the consumer is not content with the merchant's response, the consumer can notify the central server that further action is requested, whereupon the central server displays both the consumer's complaint and the merchant's response on a publicly accessible Internet web site 500.

If at 401, the merchant does not provide a merchant's response to the consumer's complaint, then the central server displays only the consumer's response on the publicly accessible Internet web site 600.

A plurality of Internet users, which are not the consumer or merchant, may visit and view the content on the Internet web site that contains the consumer's complaint and the merchant's response, if a response was provided and received by the central server 700. The plurality of Internet users are then provided with an electronic form by the central server to submit their respective opinions and analysis, in the form of assessments, of righteousness of the merchant and the consumer, which is then received by the central server, thus defining a submitted opinion of righteousness for each Internet user's opinion received 800. The opinion form may, for example, request if the Internet user has had any interactions or transactions with the complained of merchant and who, based upon the content of the complaint and response, appears to be right, or other information. The form may also solicit the Internet users' opinions and analysis as numerical representations or rankings. For example, the form may request, in a scaled format, such as 1 through 10, who is more credible or who appears more righteous. The central server, upon receiving the Internet users' opinions and analysis, compiles the numerical representations and provides an averaged numerical representation 800. The central server may then display the averaged numerical representation on the publicly accessible Internet web site for other prospective consumers to review and make a determination as to whether or not they wish to deal with that merchant 900. The averaged numerical representation may take the form of, for example, a number, a number of graphical representations, such as stars, a gauge or the like.

Accordingly, future Internet users can review whether, for example, a particular merchant has had a lot of complaints and if those complaints are deemed righteous by other Internet users that provided opinions, thus providing a quick and easy-to-understand assessment, in averaged numerical representation form, of the merchant's customer services policies and customer contentment. For example, if a merchant has a lot of consumer complaints, and the consumer complaints are rated highly with the averaged numerical representation, then a prospective consumer may decide that such merchant obviously has a customer relations issue and decide not to do business with that merchant. Alternately, if a merchant has only a few consumer complaints and the consumer complaints are rated lowly, whereas the merchant's righteousness is rated highly, via the averaged numerical representation, then the prospective consumer may decide that such complaints are irrelevant and does not represent a customer relations problem with the merchant. Accordingly, the present application provides an unbiased, independent forum that benefits both consumers and merchants in that consumers can proactively evaluate the customer service policies of a merchant, and merchants may be vindicated by other content consumers who do not believe the complaining consumer's complaint to be credible or a representative of the merchant's policies.

In an embodiment, the central server also, upon receiving an Internet user's opinion and analysis in electronic format, determines, verifies and records each Internet user's identification information, such as Internet Protocol address, and compares that to the identification information previously recorded for the consumer and the merchant when the complaint and response were received by the central server. As such, the central server can determine if either the consumer or the merchant are submitting analysis and opinions of righteousness on the consumer's complaint or the merchant's response by comparing the identification information for the merchant, consumer and Internet user, and thusly disregard such opinion and analysis in that, in all probability, it is heavily biased toward its respective position. In other words, the central server ensures that the consumer and the merchant cannot provide an Internet user opinion and analysis which may bias the averaged numerical representation.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicant's contribution. The actual scope of the protection sought is intended to be defined in the following claims when viewed in their proper perspective based on the prior art.

What is claimed is:

1. A method of managing consumer complaints comprising:
receiving a complaint from a consumer regarding a merchant;
forwarding the complaint to the merchant for a merchant's response;
displaying the complaint and any merchant's response for a plurality of users to opine as to the righteousness of the consumer and the merchant;
receiving a plurality of users' opinions of righteousness, thereby defining a submitted opinion of righteousness for each user's opinion received; and
displaying the users' opinions of righteousness as an averaged numerical representation.

2. The method as claimed in claim 1 further comprising determining the identification of each user that submits an opinion of righteousness.

3. The method as claimed in claim 2 further comprising determining the identification of the consumer.

4. The method as claimed in claim 3 further comprising determining the identification of the merchant.

5. The method as claimed in claim 4 further comprising comparing the identification of the consumer to the identification of each user that submits an opinion of righteousness.

6. The method as claimed in claim 5 further comprising comparing the identification of the merchant to the identification of each user that submits an opinion of righteousness.

7. The method as claimed in claim 6 wherein the step of displaying the users' opinions of righteousness as an averaged numerical representation includes considering opinions of users other than the consumer or merchant.

8. The method as claimed in claim 4 wherein the step of determining the identification of each user that submits an assessment of righteousness includes determining the respective user's Internet Protocol address of a computer used by the user.

9. The method as claimed in claim 8 further comprising comparing the user's Internet Protocol address to an Internet Protocol address assigned to the merchant.

10. The method as claimed in claim 8 further comprising comparing the user's Internet Protocol address to an Internet Protocol address assigned to the consumer.

11. The method as claimed in claim 1 wherein the users' opinions of righteousness include an analysis of the credibility of the merchant and the consumer.

12. The method as claimed in claim 1 wherein the users' opinions of righteousness include an analysis of the user's prior interactions with the merchant.

13. The method as claimed in claim 1 wherein the step of receiving a plurality of users' opinions of righteousness, thereby defining a submitted opinion of righteousness for each user's opinion received includes receiving a scaled numerical representation from the user.

14. A method for managing Internet consumer complaints comprising:
receiving a complaint from an Internet consumer in electronic format regarding the Internet consumer's interaction with an Internet merchant;
forwarding the complaint to the Internet merchant for an Internet merchant's response;
receiving any Internet merchant's response;
displaying the complaint and any Internet merchant's response on a publicly accessible Internet site for a plurality of Internet users' opinions of righteousness;
receiving at least one of the Internet users' opinions of righteousness in electronic format; and
displaying the Internet users' opinions of righteousness on the Internet site as a numerical representation.

15. The method as claimed in claim 14 further comprising verifying the origination of each Internet user's opinion of righteous.

16. The method as claimed in claim 15 further comprising displaying the opinions of users other than the consumer or merchant.

17. The method as claimed in claim 15 wherein the step of verifying the origination of each Internet user's opinion of righteous includes determining the Internet user's Internet Protocol address of a computer used by the Internet user.

18. The method as claimed in claim 16 further comprising comparing the Internet user's Internet Protocol address to an Internet Protocol address assigned to the Internet merchant when the Internet merchant's response was received.

19. The method as claimed in claim 17 further comprising comparing the Internet user's Internet Protocol address to an Internet Protocol address assigned to the Internet consumer when the complaint was received.

20. The method as claimed in claim 14 wherein the Internet users' opinions of righteousness includes an analysis of the credibility of the Internet merchant and the Internet consumer.

21. The method as claimed in claim 14 wherein the Internet users' opinions of righteousness includes an analysis of the Internet user's prior interaction with the Internet merchant.

22. The method as claimed in claim 14 wherein the step of forwarding the complaint to the Internet merchant for the Internet merchant's response includes automatically forwarding the complaint to the Internet merchant.

23. A system for managing Internet consumer complaints comprising:
a central server for receiving an Internet consumer's complaint regarding the Internet consumer's interaction with an Internet merchant;
a means for forwarding the complaint in electronic format to the Internet merchant for any Internet merchant's response;
an Internet web site for displaying the complaint and any Internet merchant's response for Internet users to opine as to the righteousness of the Internet consumer and the Internet merchant; and
a means for providing a numerical representation of the Internet users' opinions of righteousness and displaying it on the Internet web site.

24. A method of managing Internet consumer complaints comprising:
providing a central computer server for receiving a complaint from an Internet consumer in electronic format regarding the Internet consumer's interaction with an Internet merchant;
providing a means for forwarding the complaint to the Internet merchant for an Internet merchant's response;
providing an Internet web site for displaying the complaint and any Internet merchant's response on a publicly accessible Internet site for receiving Internet users' opinions of righteousness; and providing a numerical representation of the Internet users' assessments of righteousness on the Internet web site.
